(19) United States
(12) Patent Application Publication
(10) Pub. No.: US 2022/0096320 A1
(43) Pub. Date: Mar. 31, 2022

(54) DRIVE MECHANISM, MASSAGE MECHANISM AND MASSAGE GUN

(71) Applicant: Jun Lu, Shenzhen (CN)

(72) Inventor: Jun Lu, Shenzhen (CN)

(21) Appl. No.: 17/206,450

(22) Filed: Mar. 19, 2021

(30) Foreign Application Priority Data
Sep. 25, 2020 (CN) 202011027291.5

(51) Int. Cl. A61H 23/02

(52) U.S. Cl. CPC A61H 23/0263; A61H 2023/0281; A61H 2201/1215

(57) ABSTRACT

A drive mechanism, a massage mechanism and a massage gun are provided and belong to the technical field of power transmission. The drive mechanism includes: a drive motor; a first eccentric wheel, an end surface thereof fixedly connected to an output shaft of the drive motor and another end surface thereof provided with a first eccentric shaft; a drive lever, arranged on a side of the first eccentric wheel facing away from the drive motor and an end thereof being assembled with the first eccentric shaft by a first bearing; a second eccentric shaft, assembled on another end of the drive lever facing away from the first eccentric shaft; a second eccentric wheel, assembled with the second eccentric shaft by a second bearing and an end thereof facing away from the second eccentric shaft being provided with a fixing part; and a transmission piston, pivotally connected with the drive lever.

### FIELD OF THE DISCLOSURE

The disclosure relates to the field of power transmission, and more particularly to a drive mechanism, a massage mechanism and a massage gun.

### BACKGROUND OF THE DISCLOSURE

Professional athletes or general sports enthusiasts have experienced muscle soreness after exercise. At present, a massage gun is a good tool for people to help stretch and recover after exercise. The massage gun can relieve muscle spasm, increase blood flow, and greatly shorten muscle recovery time by applying vibration frequencies.

A conventional massage gun generally includes a massaging/knocking ball and a single eccentric wheel linkage mechanism. The eccentric wheel linkage mechanism drives the massaging ball to perform a reciprocating linear motion, thereby achieving effects of knocking and massaging. However, the eccentric wheel linkage mechanism is prone to shaking during a transmission process after the eccentric wheel linkage mechanism is installed in the massage gun, noise is easily occurred; and even, due to a long-term shaking of the eccentric wheel linkage mechanism, a damage of mechanism caused by a friction between the eccentric wheel linkage mechanism and an internal structure(s) of the massage gun would be occurred.

### SUMMARY OF THE DISCLOSURE

In the disclosure, a drive mechanism, a massage mechanism and a massage gun are provided, which aims to solve the problems that noise is easily occurred resulting from the conventional eccentric wheel linkage mechanism is prone to shaking during the transmission process after the eccentric wheel linkage mechanism is installed in the massage gun, and a damage of mechanism resulting from the friction between the eccentric wheel linkage mechanism with long-term shaking and the internal structure(s) of the massage gun would be occurred.

Specifically, in one aspect of the disclosure, a drive mechanism is provided. The drive mechanism includes: a drive motor, a first eccentric wheel, a drive lever, a second eccentric shaft, a second eccentric wheel, and a transmission piston. An end surface of the first eccentric wheel is fixedly connected to an output shaft of the drive motor, and another end surface of the first eccentric wheel is provided with a first eccentric shaft. The drive lever is provided on a side of the first eccentric wheel facing away from the drive motor, and an end of the drive lever is engaged with the first eccentric shaft by a first bearing. The second eccentric shaft is disposed on another end of the drive lever facing away from the first eccentric shaft. The second eccentric wheel is engaged with the second eccentric shaft by a second bearing, and an end of the second eccentric wheel facing away from the second eccentric shaft is provided with a fixing part. The transmission piston is pivotally connected to the drive lever.

In a preferred embodiment of the disclosure, an edge of the first eccentric wheel is provided with a marking portion, the first eccentric wheel and the second eccentric wheel have the same structure, and the marking portion of the first eccentric wheel and a marking portion of the second eccentric wheel have a same orientation.

In a preferred embodiment of the disclosure, the first eccentric wheel and the second eccentric wheel are arranged on two opposite sides of the drive lever respectively.

In a preferred embodiment of the disclosure, a mounting base for fixing the drive motor is provided between the drive motor and the first eccentric wheel.

In a preferred embodiment of the disclosure, an outer edge of the mounting base is provided with a plurality of hollow mounting sleeves spaced from one another in a circumferential direction of the mounting base, and two ends of each of the hollow mounting sleeves are respectively provided with rubber rings.

In another aspect of the disclosure, a massage mechanism is provided and may be driven by the above-mentioned drive mechanism. The massage mechanism includes: a first casing, a sliding rod, two mounting plates, and a pair of massage assemblies. The sliding rod is installed inside the first casing. The two mounting plates are provided on two opposite sides of one end surface of the first casing respectively. The pair of massage assemblies are arranged between the two mounting plates. Each of the massage assemblies includes a first connecting link, a second connecting link, and a clamping arm. An end of the first connecting link is hinged with one end of the sliding rod facing away from the transmission piston, an end of the second connecting link is hinged with one of the mounting plates, another end of the second connecting link is hinged with the end of the first connecting link facing away from the sliding rod and is further fixedly connected to the clamping arm.

In a preferred embodiment of the disclosure, the sliding rod is configured for driving the sliding rod by a drive mechanism to perform a linear reciprocating movement inside the first casing. The drive mechanism includes the transmission piston, an end of the transmission piston close to the sliding rod is provided with an assembling cavity, and an outer wall of the sliding rod is sleeved with a rubber sleeve having a diameter larger than an inner diameter of the assembling cavity and thereby the sliding rod and the transmission piston are detachably connected with each other.

In a preferred embodiment of the disclosure, two opposite sides of the outer wall of the sliding rod are provided with sliding bars respectively, and an inner wall of each of the mounting plates is provided with a sliding groove matched with one of the sliding bars.

Furthermore, in the disclosure, a massage gun is further provided. The massage gun includes: a second casing, the above-mentioned drive mechanism, and a mounting seat. The drive mechanism is installed inside the second casing. An inner wall of a side of the second casing is provided with a plurality of positioning posts matched with mounting sleeves of the drive mechanism, and an inner wall of another side of the second casing is provided with a receiving groove for installing the fixing part of the drive mechanism. The mounting seat is connected to one end of the second casing. A guide sleeve communicating with interior of the second casing and slidably assembled with the transmission piston of the drive mechanism is installed on the mounting seat.

In a preferred embodiment of the disclosure, the massage gun further includes the above-mentioned massage mechanism detachably connected with the mounting seat. The massage mechanism may clamp muscles for massage. Of course, the massage mechanism may be detachably installed, and can be replaced with other types of massage mechanisms, such as a round hammer, a shovel, etc., to meet different needs of massage.

In a preferred embodiment of the disclosure, the massage gun further includes a control circuit board arranged inside the second casing and electrically connected with the drive motor of the drive mechanism. The control circuit board is configured for controlling a rotation speed of the drive motor, and a control panel electrically connected to the control circuit board is provided on the second casing or an outer wall of a handle.

Compared with the prior art, embodiments of the disclosure mainly can achieve beneficial effects as follows.

(1) in the disclosure, the drive mechanism as provided includes: a drive motor; a first eccentric wheel, an end surface thereof being fixedly connected to an output shaft of the drive motor, and another end surface thereof being provided with a first eccentric shaft; a drive lever, disposed on a side of the first eccentric wheel facing away from the drive motor, and an end thereof being assembled with the first eccentric shaft by a first bearing; a second eccentric shaft, disposed on an end of the drive lever facing away from the first eccentric shaft; a second eccentric wheel, assembled with the second eccentric shaft by a second bearing, and an end thereof facing away from the second eccentric shaft being provided with a fixing part; and a transmission piston, pivotally connected with the drive lever. As such, in the disclosure, shakings of upward, downward, leftward and rightward of the transmission piston can be reduced, so that when the drive mechanism is applied in a massage gun, a stability of an internal structure(s) of the massage gun would not be easily affected by a reverse thrust of muscles suffered by the massage mechanism, noise and loss can be reduced; and especially, the damage of mechanism caused by a long-term shaking of the transmission piston and the friction between the transmission piston and the internal structure(s) of the massage gun would not be occurred any more, a service life of the massage gun is greatly prolonged and a use experience is improved.

(2) in the disclosure, the massage mechanism as provided is different from a conventional massage member with simple structure and single massage action. The massage mechanism of the disclosure can realize a muscle massage function(s) such as muscle kneading and/or muscle pushing, which fills a gap of functional requirement of the massage gun in this aspect and enriches the use and adaptability of the massage gun, thereby making the massage gun have a broader prospect.

In addition, in the disclosure, the massage gun as provided optimizes two aspects, i.e., the structure of drive mechanism and the massage mechanism, but the optimizations of the two aspects can be used alternatively, or in combination.

### BRIEF DESCRIPTION OF THE DRAWINGS

FIG. 1 is a schematic view of internal structures of a massage gun of the disclosure.

FIG. 2 is a schematic view of an overall structure of a drive mechanism of the disclosure.

FIG. 3 is a schematic view of an overall structure of a massage mechanism of the disclosure.

FIG. 4 is a schematic view of an overall structure of the massage gun of the disclosure.

Description of reference signs:

1. drive motor; 2. first eccentric shaft; 3. first eccentric wheel; 4. drive lever; 5. first bearing; 6. second eccentric shaft; 7. second bearing; 8. second eccentric wheel; 9. fixing part; 10. transmission piston; 11. marking portion; 12. mounting base; 13. hollow mounting sleeve; 14. rubber ring; 15. first casing; 16. sliding rod; 17. mounting plate; 18. massage assembly; 181. first connecting link; 182. second connecting link; 183. clamping arm; 19. assembling cavity; 20. rubber sleeve; 21. sliding bar; 22. sliding groove; 23. second casing; 24. positioning post; 25. mounting seat; 26. guide sleeve; 27. handle; 28. control circuit board; 29. control panel.

### DETAILED DESCRIPTION OF EMBODIMENTS

Unless otherwise stated, all technical and scientific terms used herein have same meanings as those commonly understood by those skilled in the technical field of the disclosure. The terms used in the specification of the disclosure are only for the purpose of describing specific embodiments, and are not intended to limit the disclosure. The terms “including” and “having” used in the specification, appended claims and the description of accompanying drawings of the disclosure and any variations thereof are intended to cover non-exclusive inclusions. The terms “first”, “second”, etc. in the specification and the claims, or the above-mentioned drawings are used to distinguish different objects, rather than to describe a specific order.

The phase “embodiment” mentioned in the disclosure means that a specific feature, structure or characteristic described in conjunction with the embodiment may be included in at least one embodiment of the disclosure. The appearance of the phrase in various places in the specification does not necessarily refer to the same embodiment, nor is it an independent or alternative embodiment mutually exclusive with other embodiments. Those skilled in the art explicitly and implicitly understand that the embodiments described herein can be combined with other embodiments.

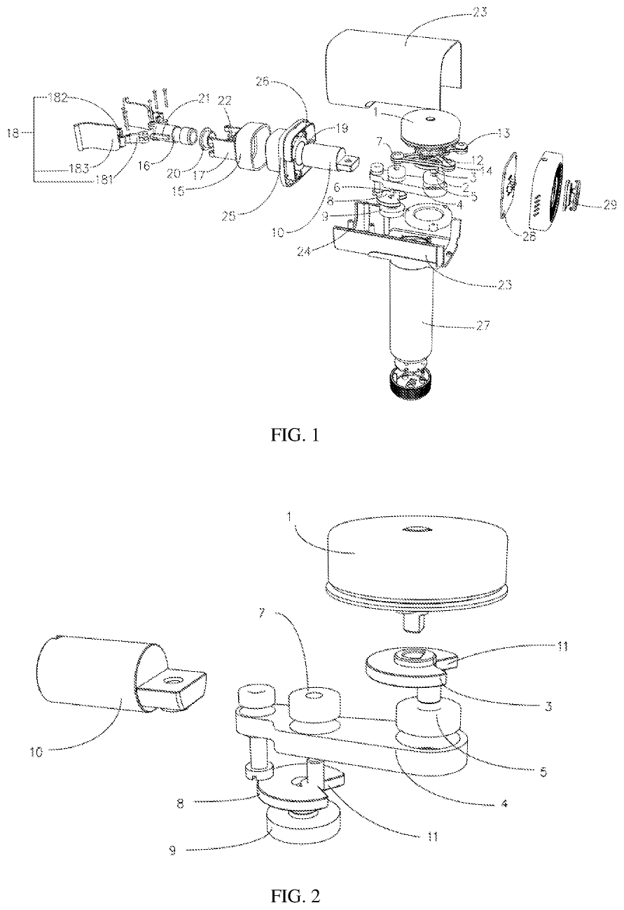

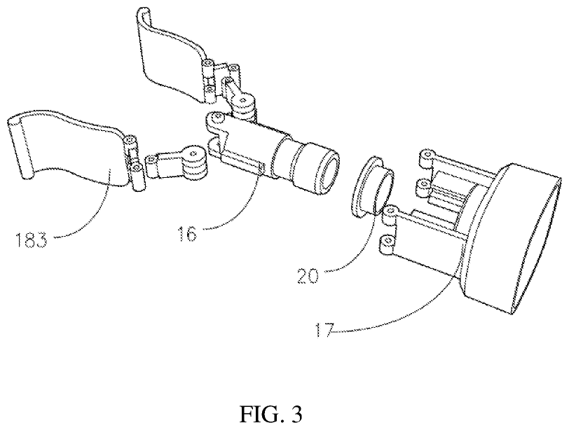

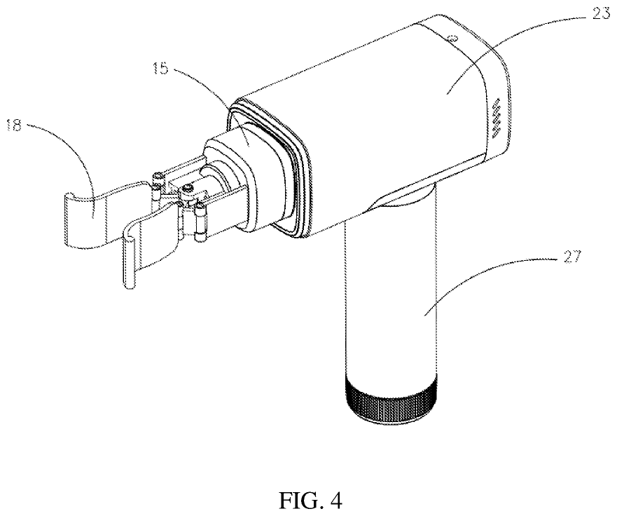

In one aspect, an embodiment of the disclosure provides a drive mechanism. Referring to FIG. 1 through FIG. 4, the drive mechanism includes: a drive motor 1, a first eccentric wheel 3, a drive lever 4, a second eccentric shaft 6, a second eccentric wheel 8, and a transmission piston 10. An end surface of the first eccentric wheel 3 is fixedly connected to an output shaft of the drive motor 1, and another end surface of the first eccentric wheel 3 is provided with a first eccentric shaft 2. The drive lever 4 is provided on a side of the first eccentric wheel 3 facing away from the drive motor 1. An end of the drive lever 4 is engaged with the first eccentric shaft 2 by a first bearing 5. The second eccentric shaft 6 is disposed on an end of the drive lever 4 facing away from the first eccentric shaft 2. The second eccentric wheel 8 is engaged with the second eccentric shaft 6 by a second bearing 7. An end of the second eccentric wheel 8 facing away from the second eccentric shaft 6 is provided with a fixing part 9. The transmission piston 10 is pivotally connected to the drive lever 4.

In the illustrated embodiment, the drive mechanism includes: the drive motor 1, the first eccentric wheel 3, the drive lever 4, the first eccentric shaft 2, and the transmission piston 10. Specifically, one end surface of the first eccentric wheel 3 is fixedly connected with the output shaft of the drive motor 1. The other end surface of the first eccentric wheel 3 is provided with the first eccentric shaft 2. The first eccentric shaft 2 is sleeved with the first bearing 5. The drive lever 4 is arranged on the side of the first eccentric wheel 3 facing away from the drive motor 1. The first eccentric shaft 2 is fixedly assembled with one end of the drive lever 4 by the first bearing 5. The transmission piston 10 is pivotally connected to the other end of the drive lever 4. When the drive motor 1 is turned on, the output shaft of the drive motor 1 rotates along one direction, the first eccentric wheel 3 assembled with the output shaft rotates correspondingly. Since the first eccentric wheel 3 is assembled with the drive lever 4 by the first eccentric shaft 2 to form an eccentric wheel linkage mechanism, when the first eccentric wheel 3 rotates, the drive lever 4 can be driven to perform a linear reciprocating movement in a plane perpendicular to the first eccentric shaft 2, and then the transmission piston 10 pivotally connected to one end of the drive lever 4 is driven to perform a linear reciprocating motion together with the drive lever 4, so that a conversion from rotational motion to linear motion is realized. In some embodiment, the drive mechanism can be installed in a massage gun, one end of the transmission piston 10 is provided with a massage mechanism (such as a massage ball) with massaging function, and the other end of the transmission piston 10 is provided with the drive mechanism of the disclosure, thereby realizing a massaging function of the massage gun by rotating of the drive motor 1.

However, since the conventional eccentric wheel linkage mechanism is prone to shaking during the transmission process, for example, after the drive mechanism is installed in a massage gun, noise is easily occurred; and even, due to a long-term shaking of the transmission piston 10, a damage of mechanism caused by a friction between the transmission piston 10 and an internal structure(s) of the massage gun would be occurred.

Therefore, in the illustrated embodiment, the drive mechanism further includes the second eccentric shaft 6, the second eccentric wheel 8, and the fixing part 9. Specifically, the second eccentric shaft 6 is assembled on an end of the drive lever 4 facing away from the first eccentric shaft 2. The second eccentric shaft 6 is sleeved with the second bearing 7. The second eccentric wheel 8 is fixedly assembled with the second eccentric shaft 6 by the second bearing 7. One end of the second eccentric wheel 8 facing away from the second eccentric shaft 6 is provided with the fixing part 9. In some embodiment, the transmission piston 10, the first eccentric wheel 3 and the second eccentric wheel 8 are arranged on the drive lever 4 in a straight line. When the first eccentric wheel 3 drives the drive lever 4 to perform a linear reciprocating motion in the plane perpendicular to the first eccentric shaft 2, under the action of the second eccentric wheel 8, the drive lever 4 opposite to the other end of the second eccentric wheel 8 can maintain a stable linear motion, thereby reducing the shaking of the drive lever 4 and thus reducing the shaking of the transmission piston 10, so that when the drive mechanism of the disclosure is applied in a massage gun, noise can be reduced, and meanwhile the damage of mechanism caused by a long-term shaking of the transmission piston 10 and the friction between the transmission piston and the internal structure(s) of the massage gun would not be occurred any more.

In a preferred embodiment of the disclosure, referring to FIG. 1 through FIG. 4, an edge of the first eccentric 3 is provided with a marking portion 11. The first eccentric 3 and the second eccentric 8 have the same structure, i.e., the second eccentric 8 also has a marking portion 11. The marking portion 11 of the first eccentric wheel 3 and the marking portion 11 of the second eccentric wheel 8 have the same orientation.

In the illustrated embodiment, in order to maintain a stable trajectory of the drive lever 4 under the actions of the first eccentric wheel 3 and the second eccentric wheel 8, it is necessary to limit angular velocities the first eccentric wheel 3 and the second eccentric wheel 8 in a movement process to be equal. At this situation, in order to ensure that a relative position between the first eccentric wheel 3 and the second eccentric wheel 8 can achieve the same angular velocity, the marking portion 11 is provided on the edge of the first eccentric wheel 3, for example a notch is provided, the first eccentric wheel 3 and the second eccentric wheel 8 have the same structure, and the marking portion 11 of the first eccentric wheel 3 and the marking portion 11 of the second eccentric wheel 8 have the same orientation.

In a preferred embodiment of the disclosure, referring to FIG. 1 through FIG. 4, the first eccentric wheel 3 and the second eccentric wheel 8 are arranged on two opposite sides of the drive lever 4 respectively.

In the illustrated embodiment, the first eccentric wheel 3 and the second eccentric wheel 8 are respectively arranged on two opposite sides of the drive lever 4 to make full use of an installation/mounting area of the drive lever 4 and avoid excessively crowded installation of components on the drive lever 4.

In a preferred embodiment of the disclosure, referring to FIG. 1 through FIG. 4, a mounting base 12 for fixing the drive motor 1 is provided between the drive motor 1 and the first eccentric wheel 3.

In the illustrated embodiment, the drive motor 1 is fixed exemplarily to the interior of the massage gun through the mounting base 12 between the drive motor 1 and the first eccentric wheel 3.

In a preferred embodiment of the disclosure, referring to FIG. 1 through FIG. 4, an outer edge of the mounting base 12 is provided with a plurality of (i.e., more than one) hollow mounting sleeves 13 spaced from one another in a circumferential direction of the mounting base 12, and two ends of each the hollow mounting sleeve 13 are respectively provided with rubber rings 14.

In the illustrated embodiment, it can play an anti-vibration role by providing the plurality of hollow mounting sleeves 13 spaced from one another in the circumferential direction of the mounting base 12 on the outer edge of the mounting base 12 and providing rubber rings 14 at two ends of each the hollow mounting sleeve 13. When the drive mechanism is applied in a massage gun, the rubber rings 14 can attenuate a vibration generated by the drive motor 1 during rotation and delivered onto a handle 27 of the massage gun.

In another aspect of the disclosure, a massage mechanism is provided, and preferably driven by the drive mechanism as mentioned above. Referring to FIG. 1 through FIG. 4, the massage mechanism includes: a first casing 15, a sliding rod 16, two mounting plates 17, and a pair of massage assemblies 18. The sliding rod 16 is installed inside the first casing 15. An end of the sliding rod 16 is detachably assembled with the transmission piston 10 of the drive mechanism. The sliding rod 16 can be driven by the drive mechanism to perform a linear reciprocating movement inside the first casing 15. Two mounting plates 17 are provided on two opposite sides of an end of the first casing 15. The pair of massage assemblies 18 are arranged between the two mounting plates 17. Each of the massage assemblies 18 includes a first connecting link 181, a second connecting link 182, and a clamping arm 183. An end of the first connecting link 181 is hinged with an end of the sliding rod 16 facing away from the transmission piston 10. An end of the second connecting link 182 is hinged with one of the mounting plates 17, another end of the second connecting link 182 is hinged with the end of the first connecting link 181 facing away from the sliding rod 16 and is further fixedly connected to the clamping arm 183.

In the illustrated embodiment, the massage mechanism includes the first casing 15, the sliding rod 16, the mounting plates 17, and the massage assembles 18. Specifically, the sliding rod 16 is installed inside the first casing 15. One end of the sliding rod 16 is detachably assembled with the transmission piston 10 of the drive mechanism, and the sliding rod 16 can be driven by the drive mechanism to perform a linear reciprocating movement inside the first casing 15. In some embodiment, the end of the transmission piston 10 close to the sliding rod 16 is provided with an assembling cavity 19, an outer wall of the sliding rod 16 is sleeved with a rubber sleeve 20 with a diameter greater than the inner diameter of the assembling cavity 19, and thereby the sliding rod 16 and the transmission pistons 10 are detachably connected with each other by the rubber sleeve 20. The mounting plates 17 are two in number/quantity, and the two mounting plates 17 are respectively provided on two opposite sides of one end surface of the first casing 15. The massage assemblies 18 are provided in one pair, and arranged between the two mounting plates 17. Each of the massage assemblies 18 includes the first connecting link 181, the second connecting link 182, and the clamping arm 183. One end of the first connecting link 181 is hinged with one end of the sliding rod 16 facing away from the transmission piston 10. One end of the second connecting link 182 is hinged with one of the mounting plates 17, the other end of the second connecting link 182 is hinged with the end of the first connecting link 181 facing away from the sliding rod 16 and is further fixedly connected to the clamping arm 183. When the drive mechanism drives the transmission piston 10 to perform a linear reciprocating movement, the transmission piston 10 drives the sliding rod 16 to make a linear reciprocating movement inside the first casing 15 and thereby drives the two clamping arms 183 of the massage assemblies 18 to mutually approach or move away from each other. When the massage mechanism is applied in the massage gun, the two clamping arms 183 can imitate a manual massage action to achieve a massage effect.

In a preferred embodiment of the disclosure, referring to FIG. 1 through FIG. 4, two opposite sides of the outer wall of the sliding rod 16 are provided with sliding bars 21 respectively, and an inner wall of each of the mounting plates 17 is provided with a sliding groove 22 matched with one of the sliding bars 21.

In the illustrated embodiment, by providing the sliding bars 21 on the two opposite sides of the outer wall of the sliding rod 16 and by providing the sliding groove 22 slidably engaged with the sliding bar 21 on the inner wall of each of the mounting plates 17, it can play a guiding role for sliding of the sliding rod 16, a stability of movement can be improved consequently.

Furthermore, in the disclosure, a massage gun is provided. Referring to FIG. 1 through FIG. 4, the massage gun includes: a second casing 23, the above-mentioned drive mechanism installed inside the second casing 23, a mounting seat 25, the massage mechanism, and a handle 27. An inner wall of a side of the second casing 23 is provided with a plurality of positioning posts 24 matched with mounting sleeves of the drive mechanism, and an inner wall of another side of the second casing 23 is provided with a receiving groove for installing the fixing part of the drive mechanism. The mounting seat 25 is connected to one end of the second casing 23. A guide sleeve 26 communicating with interior of the second casing 23 and slidably assembled with the transmission piston 10 of the drive mechanism is installed on the mounting seat 25. The massage mechanism as mentioned above is detachably connected to the mounting seat 25. The handle 27 is connected to the outer wall of the second casing 23.

In the illustrated embodiment, the massage gun includes: the second casing 23, the drive mechanism, the positioning posts 24, the receiving groove (not shown in the figures), the mounting seat 25, the massage mechanism, and the handle 27. Specifically, the drive mechanism is installed inside the second casing 23. The positioning posts 24 are multiple (i.e., more than one) in number, and the multiple positioning posts 24 are arranged on an inner wall of one side of the second casing 23 to match with the mounting sleeve of the drive mechanism. The receiving groove is provided on the inner wall of the other side of the second casing 23 and used for installing the fixing part of the drive mechanism. The mounting base 25 is connected to one end of the second casing 23. The guide sleeve 26 communicating with the interior of the second casing 23 and slidably assembled with the transmission piston 10 of the drive mechanism is mounted on the mounting base 25. The massage mechanism is fixed on the mounting seat 25 by a thread or a snapping structure or a hoop structure or a soft rubber structure, so as to achieve a detachable connection. The handle 27 is connected to the outer wall of the second casing 23. In some embodiment, the massage mechanism can include the above-mentioned clamping arms 183 to achieve the function of imitating manual massage. In another embodiment, the massage mechanism can include a conventional massage ball that can achieve the function of knocking massage, and the user can choose types of the massage mechanism.

In a preferred embodiment of the disclosure, referring to FIG. 1 through FIG. 4, the massage gun further includes a control circuit board 28 arranged inside the second casing 23 and electrically connected to the drive motor 1 of the drive mechanism. The control circuit board 28 is configured for controlling a rotation speed of the drive motor 1. The second casing 23 or an outer wall of the handle 27 is provided with a control panel 29 electrically connected to the control circuit board 28.

In the illustrated embodiment, the massage gun further includes the control circuit board 28. The control circuit board 28 is provided inside the second casing 23 and electrically connected to the drive motor 1 of the drive mechanism. The control circuit board 28 is configured for controlling the rotation speed of the drive motor 1. The outer wall of the second casing 23 or the handle 27 is provided with the control panel 29 electrically connected to the control circuit board 28. The control panel 29 includes buttons respectively configured for controlling the rotation speed, and turning off and turning on of the drive motor 1.

It should be noted that for the foregoing embodiments, for the sake of simple description, they are all expressed as a combination of a series of actions, but those skilled in the art should be known that the disclosure is not limited by the described sequence of actions, because according to the disclosure, some steps may be performed in other order or simultaneously. Secondly, those skilled in the art should also be known that the embodiments described in the specification are all preferred embodiments, and the actions and modules involved are not necessarily required by the disclosure.

In the several embodiments provided in the disclosure, it should be understood that a device as disclosed may be implemented in other ways. For example, device embodiments as above described are only illustrative. For example, a division of above-mentioned units is only a division of logical functions. In an actual implementation, there may be other division methods, for example, multiple units or components can be combined or integrated into another system, or some features can be ignored, or not implemented. In addition, mutual couplings or communication connections as illustrated or discussed may be realized through some interfaces, indirect couplings or communication connections between devices or units may be electrical or other forms.

Units described above as separate components may or may not be physically separated, and parts illustrated as units may or may not be physical units, that is, they may be located in one place, or they may be distributed on multiple network units. Some or all of the units may be selected according to actual needs to achieve objectives of solutions of the embodiments.

The above embodiments are only used to illustrate technical solutions of the disclosure, but not to limit the protection scope of the disclosure. Apparently, the described embodiments are only some of embodiments of the disclosure, rather than all embodiments of the disclosure. Based on these described embodiments, all other embodiments obtained by those skilled in the art without creative effort fall within the scope of the disclosure. Although the disclosure has been described in detail with reference to the above-mentioned embodiments, those skilled in the art can still combine, add, delete, or make other amendments to the features of the various embodiments of the disclosure according to actual situations without any creative effort to thereby obtain other different technical solutions without deviating from the concept of the disclosure, and these technical solutions also belong to the protection scope of the disclosure.

What is claimed is:

1. A drive mechanism, comprising:
a drive motor;
a first eccentric wheel, wherein an end surface of the first eccentric wheel is fixedly connected to an output shaft of the drive motor, and another end surface of the first eccentric wheel is provided with a first eccentric shaft;
a drive lever, provided on a side of the first eccentric wheel facing away from the drive motor, wherein an end of the drive lever is engaged with the first eccentric shaft by a first bearing;
a second eccentric shaft, disposed on an end of the drive lever facing away from the first eccentric shaft;
a second eccentric wheel, engaged with the second eccentric shaft by a second bearing, wherein an end of the second eccentric wheel facing away from the second eccentric shaft is provided with a fixing part; and
a transmission piston, pivotally connected to the drive lever.

2. The drive mechanism according to claim 1, wherein an edge of the first eccentric wheel is provided with a marking portion, the first eccentric wheel and the second eccentric wheel have the same structure, and the marking portion of the first eccentric wheel and a marking portion of the second eccentric wheel have a same orientation.

3. The drive mechanism according to claim 2, wherein the first eccentric wheel and the second eccentric wheel are arranged on two opposite sides of the drive lever respectively.

4. The drive mechanism according to claim 1, wherein a mounting base for fixing the drive motor is provided between the drive motor and the first eccentric wheel.

5. The drive mechanism according to claim 4, wherein an outer edge of the mounting base is provided with a plurality of hollow mounting sleeves spaced from one another in a circumferential direction of the mounting base, and two ends of each of the hollow mounting sleeves are respectively provided with rubber rings.

6. A massage mechanism, comprising:
a first casing;
a sliding rod, installed inside the first casing;
two mounting plates, provided on two opposite sides of an end surface of the first casing; and
a pair of massage assemblies, arranged between the two mounting plates, wherein each of the pair of massage assemblies comprises a first connecting link, a second connecting link and a clamping arm;
wherein an end of the first connecting link is hinged with an end of the sliding rod facing away from the transmission piston, an end of the second connecting link is hinged with one of the mounting plates, another end of the second connecting link is hinged with another end of the first connecting link facing away from the sliding rod and is further fixedly connected to the clamping arm.

7. The massage mechanism according to claim 6, wherein the sliding rod is configured for driving the sliding rod by a drive mechanism to perform a linear reciprocating movement inside the first casing;
wherein the drive mechanism comprises the transmission piston, an end of the transmission piston close to the sliding rod is provided with an assembling cavity, and an outer wall of the sliding rod is sleeved with a rubber sleeve having a diameter larger than an inner diameter of the assembling cavity and thereby the sliding rod and the transmission piston are detachably connected with each other.

8. The massage mechanism according to claim 6, wherein two opposite sides of the outer wall of the sliding rod are provided with sliding bars respectively, and an inner wall of each of the mounting plates is provided with a sliding groove matched with one of the sliding bars.

9. The massage mechanism according to claim 7, wherein two opposite sides of the outer wall of the sliding rod are provided with sliding bars respectively, and an inner wall of each of the mounting plates is provided with a sliding groove matched with one of the sliding bars.

10. A massage gun, comprising:
a second casing;
the drive mechanism according to claim 1, installed inside the second casing, wherein an inner wall of a side of the second casing is provided with a plurality of positioning posts matched with mounting sleeves of the drive mechanism, and an inner wall of another side of the second casing is provided with a receiving groove for installing the fixing part of the drive mechanism; and
a mounting seat, connected to one end of the second casing, wherein a guide sleeve communicating with interior of the second casing and slidably assembled with the transmission piston of the drive mechanism is installed on the mounting seat.

11. The massage gun according to claim 10, further comprising a massage mechanism detachably connected to the mounting seat;
wherein the massage mechanism comprising:
a first casing;
a sliding rod, installed inside the first casing, wherein an end of the sliding rod is movably assembled with the transmission piston of the drive mechanism, and the sliding rod is capable of being driven by the drive mechanism to perform a linear reciprocating movement inside the first casing;
two mounting plates, arranged on two opposite sides of an end surface of the first casing; and
a pair of massage assemblies, arranged between the two mounting plates, wherein each of the pair of massage assemblies comprises a first connecting link, a second connecting link and a clamping arm;
wherein an end of the first connecting link is hinged with an end of the sliding rod facing away from the transmission piston, an end of the second connecting link is hinged with one of the mounting plates, another end of the second connecting link is hinged with another end of the first connecting link facing away from the sliding rod and is further fixedly connected to the clamping arm.

12. The massage gun according to claim 10, wherein an end of the transmission piston near the sliding rod is provided with an assembling cavity, and an outer wall of the sliding rod is sleeved with a rubber sleeve having a diameter larger than an inner diameter of the assembling cavity and thereby the sliding rod and the transmission piston are detachably connected with each other.

13. The massage gun according to claim 11, wherein an end of the transmission piston near the sliding rod is provided with an assembling cavity, and an outer wall of the sliding rod is sleeved with a rubber sleeve having a diameter larger than an inner diameter of the assembling cavity and thereby the sliding rod and the transmission piston are detachably connected with each other.

14. The massage gun according to claim 10, wherein two opposite sides of the outer wall of the sliding rod are provided with sliding bars respectively, and an inner wall of each of the mounting plates is provided with a sliding groove matched with one of the sliding bars.

15. The massage gun according to claim 11, wherein two opposite sides of the outer wall of the sliding rod are provided with sliding bars respectively, and an inner wall of each of the mounting plates is provided with a sliding groove matched with one of the sliding bars.

16. The massage gun according to claim 10, further comprising: a handle connected to an outer wall of the second casing.

17. The massage gun according to claim 11, further comprising: a handle connected to an outer wall of the second casing.

18. The massage gun according to claim 10, further comprising: a control circuit board arranged inside the second casing and electrically connected with the drive motor of the drive mechanism; wherein the control circuit board is configured for controlling a rotation speed of the drive motor, and a control panel electrically connected to the control circuit board is provided on the second casing or an outer wall of a handle.
